(19) United States
(12) Patent Application Publication
(10) Pub. No.: US 2015/0141538 A1
(43) Pub. Date: May 21, 2015

(54) METHOD AND APPARATUS FOR MODIFYING POLYMER COMPOSITIONS

(71) Applicant: Adhesive Technologies, Inc., Hampton, NH (US)

(72) Inventors: Peter. S. Melendy, Hampton, NH (US); Dennis J. Fitzmeyer, Hampton, NH (US); Joseph D. Sordillo, Hampton, NH (US)

(21) Appl. No.: 14/413,799

(22) PCT Filed: Jul. 10, 2013
(86) PCT No.: PCT/US13/49888

§ 371 Date: Jan. 9, 2015

Related U.S. Application Data
(60) Provisional application No. 61/669,942, filed on Jul. 10, 2012.
(60) Provisional application No. 61/787,248, filed on Mar. 15, 2013.

(51) Int. Cl. C08J 9/32; C09J 9/00; C09J 201/00

(52) U.S. Cl. CPC C08J 9/32; C09J 201/00; C09J 9/00; C08J 2300/00; C08J 2203/22; C08J 2333/20; C09J 2201/61
USPC 521/59; 524/599; 524/1; 521/60; 521/56; 422/198

(57) ABSTRACT

A system for applying a melted polymer/hot melt adhesive includes structure for adding one or more components to the polymer/hot melt stream at selected locations of the stream depending on the desired final characteristics of the polymer/hot melt adhesive, the heat histories of the polymer/hot melt adhesive and the modifying component, and the physical or chemical characteristics of the modifying component. The modifying component can be supplied in a fluid carrier.

### TECHNICAL FIELD

This invention relates to the art of polymers and in preferred embodiments to expanded polymers and related components used in hot melt adhesives and similar heated adhesives.

### BACKGROUND ART

The use of melted polymers, particularly hot-melt adhesives, for a wide variety of purposes is known. In some of these uses, the polymer is provided in the form of sticks, and the applicator is self contained and configured to be held in a user's hand. Examples of this type of applicator are a variety of hand-held glue guns, which are useful in both industrial applications and home craft projects. Hand-held glue guns that accept glue in discrete pieces for melting are also known. Another example of a known system for applying a melted polymer is the bulk or tank type system. In such systems a reservoir of polymer is held in a tank that is typically heated to maintain the polymer at a desired temperature. Typically the tank holds the polymer at a temperature at or near its melting temperature such that the polymer can be pumped through a hose to an applicator, which may also be held in the hand of an operator. The hose can be heated to maintain or raise the temperature of the polymer to a desired temperature during its passage through the hose from the tank to the applicator.

Formulation of polymer mixtures, such as hot melt polymers, continuously in-line at the manufacturing location where the polymers are applied is also known. For example, U.S. Pat. No. 5,605,720 (Allen) describes an in-line continuous method of formulating and applying a hot melt adhesive to a substrate, and published United States patent application 2011/0244232 (Hall et al.) describes a similar system. The Allen system utilizes continuous metering of raw materials into an extruder, heating the raw materials, and discharging the melt from an applicator onto a substrate. The Hall et al. application discloses combining a styrenic block copolymer with a second copolymer, such as a polyolefin, in desired proportion, and application of the mixture to a substrate. These systems are by their nature large, expensive, and cumbersome and, moreover, are unable to address such aspects as controlling or modifying processing temperatures.

There have also been efforts to extend or increase the coverage of heated polymers, particularly hot-melt adhesives, in an effort to reduce the overall cost of the polymer materials by lowering the amount of adhesive required per unit application. A frequent attempt was to add fillers to a polymer that were of lower cost than the polymers, but this often had the disadvantage of increasing the viscosity of the polymers as well as their densities.

Attempts have also been made to reduce the densities of the polymers, for example by injecting gasses (e.g., carbon dioxide or nitrogen gas) that expand into bubbles when the polymer is applied at atmospheric pressure, by adding chemical blowing agents that are activated in a variety of ways, or by adding micro-spheres that expand when activated by heating the mixture to a temperature at which the micro-spheres expand. These techniques extend the coverage of the polymer by lowering the volume of the polymer required per unit area.

In one system proposed in PCT/US2012/020974, the disclosure of which is incorporated herein by reference, a heated tank maintains a mixture of micro-spheres and hot melt adhesive/polymer at a temperature below the activation/expansion temperature of the micro-spheres, and the mixture is subsequently heated to the activation temperature at a point near the discharge nozzle where the micro-sphere expansion is maintained under pressure until the adhesive is applied. While this system has been found to be effective generally, the system is limited by the kind of hot melt adhesives that have processing temperatures low enough to ensure that premature expansion does not occur. This can place a restriction on the use of this invention with most known hot-melt formulas. Also, when the system is maintained at a temperature that is above the activation temperature of the micro-spheres, even when the system is maintained under a pressure high enough to control expansion of the spheres, there can be oxidation of the polymer of the shells of the spheres, which darkens and softens the sphere material and may allow the entrapped gas to escape. The combined effect at application will be higher density, darkened hot melt adhesive with collapsed micro-spheres.

A problem encountered in the use of blowing agents or micro-spheres was the tendency of these components to separate from the mixture at lower pressures. Further at temperatures above the activation temperature, micro-spheres can oxidize and darken, and at elevated temperatures their expanded polymer walls can rupture to release the entrapped gas, which then escapes from the polymer during application. Micro-spheres are typically processed into polymers below the activation temperatures of the micro-spheres, but when reheated, as in a supply tank, their reduced density can cause the spheres to separate from the polymer and float out of the molten polymer mix, either during processing or application. This limits the usefulness of micro-spheres in any formulation where the processing or application temperatures exceed the minimum activation temperature of the micro-spheres.

Many of the modifying components discussed above are sensitive to temperature, and change structurally or chemically by exposure to increased temperatures. In those instances it is important to know the temperatures and related conditions to which the component has been exposed, and this can be called the heat history of the component. Particular examples of modifying components whose heat histories can be very important are microspheres and temperature activated chemical agents that are or will be combined with hot-melt adhesive polymers. Prior systems using such modifying components have been unable to control the heat history of modifying components that are temperature sensitive, which has restricted the practical use of such components in polymer systems.

### SUMMARY OF THIS INVENTION

In accordance with the invention a method and apparatus for its practice are disclosed that introduce one or more modifying components into a polymer stream in a manner that optimizes the effects of temperature, pressure, and other characteristics of the modifying components on the polymer. The modifying component may be an expansion component that is introduced at a point in the flow path, for example, of a hot melt adhesive. The location in the polymer flow stream at which the modifying component is added to the polymer, and the conditions such as temperature and pressure, are selected to optimize the processing requirements of a given application, the modifying component, and the polymer. The invention allows greater flexibility in selection or design of the modifying component to include a variety of polymer-property modifiers in addition to density-lowering modifiers. Furthermore, the invention provides greatly improved results when the property-modifying components require conditions such as a particular reaction or mixing time to be effective.

An important feature of the invention is management of the temperature of the polymer and the temperature of the modifying component. The provision of a heat exchanger or the application of power to a heat exchanger depends on the particular formulation of the base polymer and that of the modifying components to be added to the polymer stream. In some embodiments the heat capacity and other thermal and physical characteristics of the base polymer are such that the polymer is itself able to heat the modifying components to the necessary activation temperature without additional heating. For example, if a modifying component will activate at a temperature that will not char the base polymer or degrade the supply hose, the modifying component can be introduced into the stream at any location that allows adequate time for activation. In some cases that location will be just before the discharge nozzle, and in other cases it can be a greater distance upstream of the discharge nozzle. In those cases where the temperature to which the base polymer must be heated to activate the modifying component would char the base polymer or damage the supply hose or cause other negative effects, the system can include a heat exchanger at or near the discharge nozzle to raise the temperature of the base material or the mixture of the base material and the modifying component to the activation temperature just before discharge of the mixture to avoid or reduce deleterious effects caused by the increased temperature.

In another example the optimum temperatures of the base polymer and the modifying components are the essentially the same. In that case a heat exchanger might not be required. In the situation where the optimum temperature would damage the supply hose or other parts of the system, however, a heat exchanger near the discharge nozzle would be provided to allow the supply hose to operate at a lower temperature. But, where the optimum temperatures of the polymer and the modifying components are the same, the modifying components can be introduced into the base polymer stream at almost any point. Of course, other considerations such as the heat history of the polymer or modifying component might suggest that the modifying component be added earlier or later.

In another example, the optimum or activation temperature of the modifying component is higher than the optimum temperature of the base polymer. Here a heat exchanger would be used to raise the temperature of the mixture just before discharge, unless the modifying component is introduced into the base polymer already at its optimum temperature and the heat capacity of the polymer is such that it won't be cooled significantly by introduction of modifying component at a lower temperature.

In a still further example, the optimum temperature of the base polymer is higher than that of the modifying component. In this case, the modifying component can be added at a point close enough to the point of application that does not result in damage to the modifying component.

Thus, the present invention provides much greater flexibility in the selection of base polymers and modifying components, expanding or otherwise, than available in the prior art. This flexibility allows the user to obtain the desired temperature with much fewer compromises required. By providing introduction of the expanding or modifying components at the location that optimizes their effectiveness and providing control of the temperature of the mixture independent of the temperature of a supply tank, the system of the invention essentially removes the importance of the tank temperature insofar as it affects activation of the modifying components. This allows the supply hose to be operated at cooler temperatures and allows optimum control of the heat histories of the base polymer and the modifying components. The result is increased effectiveness of the polymer for a wider variety of uses.

As well, the invention renders the particular type of supply tank of less importance. A known bulk tank maintains a reservoir of liquid polymer with or without additives at a constant temperature, and another maintains the polymer in block form and removes polymer from the block (e.g., by scraping) for melting and subsequent supply to the hose. The system of the invention is capable of using either type of tank more effectively because of the flexibility of heating by a separate heat exchanger and mixing the modifying components at selected locations in the base polymer stream. The invention further allows the use of lower cost tanks, because the control system can be less complex, and the ability to use lower temperatures in the tanks reduces maintenance and cost by permitting use of less expensive materials in the construction of the tank.

Furthermore, the invention can be easily applied to a variety of existing tank systems. For example, a heat exchanger control system, which would include temperature sensors and control electronics, such as a microprocessor programmed to control temperatures, pressures, flow rates, and mixing locations, can be retrofitted to an existing tank and heat exchanger, with the modifying components being introduced into the flow stream at one or more inlet locations provided by simple structural modifications of the existing equipment. Flow rates of the existing system can be determined, for example, by detecting operation of the polymer pump (e.g., by detecting electronic pulses provided to or received from the pump), and temperatures at various locations can be detected by existing sensors or by attaching additional thermocouples or other sensors as needed.

The invention also contemplates mixing the expanding or property modifying components in several ways that are known in the art. For example, direct injection of the modifying components can be used in many situations. In other situations, helical mixers (static mixers) will be desirable. Further, as described herein the modifying components themselves may cause adequate mixing, as would be the case where chemical foaming agents are used.

In a preferred embodiment, a polymer or hot melt adhesive is heated to a temperature at which it readily flows. In one example, a hot melt adhesive composition can be held in a heated tank and pumped through a heated hose to a discharge nozzle at or near its intended application temperature, a known manner of hot melt use. In an alternative method envisioned in PCT/US2012/020974 the polymer/adhesive is maintained in the heated tank and heated hose below its intended application temperature and then heated at or near the discharge nozzle to the intended application temperature as it flows through a heat exchanger. The expansion component—introduced into either system under enough pressure to control its introduction into the liquid stream in or beyond the heated hose—is then caused to expand either when the temperature of the polymer stream to which it has been added is increased beyond the activation temperature of the expansion component by the heat exchanger or by thermal transfer from the polymer/hot melt stream itself that is already at or above the activation temperature.

The expanding component may be a chemical agent, micro-spheres, volatile liquids such as water or alcohol or other temperature-sensitive expansion component known in the art. It is further envisioned that modifying materials which would alter the characteristics of a polymer or hot melt adhesive might also be designed into the expanding component. These modifiers might include a catalyst, plasticizing materials or a physical material that adds strength or other properties. Thus, while we have characterized this invention around the concept of its use with materials intended to expand and lower the density of the polymer/hot melt adhesive into which it is being introduced, this system provides additional opportunities to introduce other materials as well, and their intended impact may not be specifically to lower the density.

In one embodiment, the expanding component comprises micro-spheres, such as that known in the art by the trademark EXPANCEL. These micro-spheres can be used effectively to expand a heated liquid polymer/hot melt adhesive when raised to a temperature at which they expand, as is described in the noted PCT application. One of the benefits of the present invention, in addition to those disclosed in the PCT application, is that the micro-spheres used as the expanding component can be specifically designed or selected for a specific application temperature. There are many different types of micro-spheres available, or that can be custom designed, and each of these presents unique properties, including unique activation temperatures. While the PCT application system disclosed use of micro-spheres that were activated at temperatures below the optimum temperature of the polymer/hot melt adhesive, the present invention allows use of a wider range of both micro-spheres and polymers and, thus, provides additional advantages.

In accordance with another embodiment of the invention, the modifying component is placed in a flowable carrier, such as an oil or other liquid that facilitates introducing the modifying components into the polymer/hot melt adhesive stream. In some embodiments the modifying components are suspended in the carrier to form a slurry, but in other embodiments the modifying components are dissolved in the carrier. In other embodiments the carrier is a fluidized material. It is preferred but not essential that the carrier be compatible with the polymer/hot melt adhesives. The mixture should be fluid enough such that it flows ideally—but not essentially—at a temperature below that which would cause activation of the modifying components. One envisioned composition would be a mixture of micro-spheres and liquid oil at a weight ratio of around 50:50. One key benefit of this ratio is that addition of the expanding component into the polymer/hot melt adhesive stream allows the latent heat of the polymer stream to raise the temperature of the expanding component above its activation temperature, thus simplifying the thermal transfer process. However, other proportions can be used as long as the resultant mixture of carrier and modifying component can be pumped and introduced into the polymer/hot melt adhesive stream and mix well.

The flowable carriers may, however, be solid at temperatures such as room temperature and melted to be flowable at the time of introduction into the polymer/hot melt stream. As an example, a wax that is solid at room temperature can be mixed with one or more modifying components such as microspheres and then cooled to provide a wax block with microspheres embedded therein. This embodiment facilitates supply of the modifying components because the blocks can be provided in a variety of forms, such as cylindrical cartridges, with selected modifying components and at varying concentrations. As well, a user can select a block with a particular composition to provide the desired properties of the polymer/hot melt. The block can then be melted just before injection into the polymer/hot melt stream by contact with a heated platen or by placing it in a pressurized melting chamber. A carrier solid at room temperature, such as a wax or a resin, with a modifying component therein, can be made flowable also by being fluidized, which allows it to be injected into the polymer/hot melt stream at a desired flow rate. The carrier (e.g., wax or resin)/modifying component proportion is chosen depending on the expected polymer/hot melt flow rate and the carrier flow rate.

Waxes typically melt at somewhat lower temperatures (e.g., 200° F.) and are therefore offer particular utility as carriers for modifying components that activate at lower temperatures. In those cases where the pressure of the polymer/hot melt stream is large (e.g., 100-200 psi) the pressure of the melted wax (or any other carrier) can be increased easily with known gear pumps and then injected.

There is a wide variety of alternative configurations and formulations for the modifying component. In one embodiment, the modifying component is combined with a carrier. For example, a mixture of 40% microspheres (by weight of the carrier/modifying component mixture) sold under the trademark EXPANCEL 951 DU and 60% mineral oil sold under the trademark DRAKEOL with surfactants to provide a stable slurry is useful. The microspheres are preferably from 0.5% to 5% by weight of the final polymer stream including the carrier, modifying component and polymer, but other proportions may be found useful.

DRAKEOL is only one example of oil that has been found useful as a carrier, and it is noted that there is a variety of carriers that are compatible with polymers. For example, in another embodiment, the carrier for the expanding or modifying component may be water or alcohol. In these embodiments, the fluid itself may also contribute to the density reduction by volatizing as it reaches its vaporization temperature.

As well, the particular ratios may vary depending upon a number of factors, such as for example the activation temperature and expanded volume of the expanding component, the location at which the expanding component is introduced into the liquid polymer/hot melt, the carrier used with the particular expanding component, and whether the carrier or expanding component also modifies the characteristics of the polymer/hot melt adhesive itself. The amount of this mixture provided to the base polymer also depends on the desired amount of the modifying component (e.g., EXPANCEL). Thus if a 1% EXPANCEL proportion in the polymer/carrier/modifying component mixture is desired, the proportion of slurry added to the base polymer will be determined by the proportion of EXPANCEL in the slurry.

In another embodiment a slurry comprising a chemical foaming agent suspended in a fluid such as DRAKEOL is introduced into the polymer stream. The chemical foaming agent may be, for example, those sold under the trademarks CELOGEN and ENDEX, which generate CO₂ or N₂ bubbles when activated and tends to lower the density of the polymer. While the CELOGEN or other blowing agent can be used exclusively to provide an economical density-reduction system, an expanding component such as EXPANCEL can be combined with the chemical foaming agent in the slurry. The joint impact of this mixture can result in a greater decrease in the overall density because the expanding gas will create space into which the EXPANCEL micro-spheres can expand. Moreover, additional benefits such as increased strength and heat resistance similar to those achieved with micro-spheres alone as a modifying component can be achieved, as well as increases in resilience, particularly with rubber based plastics. It will be appreciated further that modifying components such as CELOGEN may require additional time, when compared to micro spheres, to decompose and release the foaming gases once it reaches its activation temperature, and that this is easily accommodated by the invention.

The expanding slurry could also include materials which would plasticize or modify the polymer/hot melt adhesive itself. For example, liquid plasticizers, such as phthalic acid esters, including di-octyl phthalate and sebaccyl phthalate, and polymeric plasticizers can be used preferably in proportions of between 10% and 20% by weight of the final modifying component/carrier/polymer. These can also be used with CELOGEN, EXPANCEL, and other modifying components to modify the physical or adhesive properties of the polymer/hot melt adhesive, and in such cases, the ratio of the expanding component would depend also upon the nature of the carrying fluid and its impact on the polymer/hot melt adhesive. In addition, the carrier and modifying component mixture is not a slurry in those cases where the modifying components are soluble in the carrier. Moreover, the carrier is not limited to liquids per se but can be other flowable mediums, such as a fluidized stream that is capable of carrying the modifying components into the polymer stream.

It is also envisioned that liquid resins can serve as the expanding component alone or mixed with another fluid such as DRAKEOL. These might provide improved adhesive characteristics in addition to the density reduction benefits achieved by components like EXPANCEL. Further to that option, it is envisioned that a heated, expanding component mixture with microspheres such as EXPANCEL and other phenolic micro-balloons, or foaming agents such as CELOGEN suspended in the heated fluid, but below their activation temperatures, could be used as an alternative to a room-temperature mixture, as the hot melt raw materials into which they are mixed can be used to heat the modifying components further to the activation temperatures.

There is also the potential to include other kinds of modifying components—either as part of the fluid or as another suspended component. Examples of these are waxes, isocyanates, peroxides, oils, tackifying resins, and fillers. For example, waxes such as microcrystalline waxes, Fisher-Tropsch waxes, oxidized hydrocarbons, and polyethylene waxes can be added in suspension to a carrier alone or in combination with an expanding component to adjust the melt viscosity, alter the set time, or reduce tack of the polymer/hot melt adhesive. Waxes are preferably provided in the proportion of from 5% to 15% by weight of the final polymer product.

Examples of isocyanates are toluene diisocyanate, Papi, and Mondur (polymeric toluene diisocyanate). These can be used to crosslink, raise heat and moisture resistance, and improve adhesion and can be provided in the range of from 1% to 5% by weight of the final polymer product.

Examples of peroxides include Bezoyl peroxide and are preferably provided at a proportion of from 0.1% to 5% by weight of the final polymer product. Peroxides are used to crosslink, raise heat and moisture resistance and to improve adhesion.

Examples of oils are hydrocarbons, soy oil, Tall oil, and linseed oil and are preferably provided at a proportion of from 5% to 20% by weight of the final polymer product. Oils are used to improve low temperature properties and to lower viscosity.

Examples of tackifying resins are C-5 hydrocarbons, C-9 hydrocarbons, cyclopentadiene, pentaerythtitol ester or Abietic acid (also sold under the trademark FORAL) and are preferably provided at a proportion of 10% to 40% by weight of the final polymer product. Tackifying resins are used to improve adhesion and/or lower viscosity.

Glass beads may be used effectively at proportions preferably between 5% and 10% by weight of the final polymer product.

Colorants may also be useful to provide a desired color to the polymer and are preferably used in proportions from 1% to 3% by weight of the final polymer product.

Additionally fillers such as calcium carbonate, aluminum trioxide, clay, and wood dust can be added to the carrier to alter the characteristics of the base polymer/hot melt adhesive and are preferably provided in the proportion of between 5% and 20% by weight of the final polymer product.

It is within the scope of this invention also that the modifying component be a catalyst that triggers a further reaction after a mixing action that is at least in part caused by the expansion of the microspheres or foaming agent provides enough blending of the components to initiate a chemical reaction. One benefit of this approach is that the modifying component mixture isolates the catalyst from the polymer/hot melt adhesive until the point of application or even after the exit of the polymer/hot melt adhesive from the system, and the expanding gases or micro-spheres serve as the mixing mechanism that blends the catalyst into the polymer/hot melt adhesive stream. For example, microspheres can be provided with various encapsulates, which include one or more modifying components, such as a wax or any of many different modifying components (including those disclosed herein) that would alter the characteristics of the base material when released from the microspheres. When provided in combination with an expanding gas, such as air or chemical foaming agents, the expansion mixes the encapsulated material with the base material at the optimum temperature and at the optimum time.

The invention also envisions the use of polymer/hot melt adhesive formulations that by design anticipate the introduction of modifying components to achieve their desired final characteristics. It is possible under this approach to alter the physical properties or characteristics of a polymer/hot melt adhesive so that during application those properties are changed to optimize a specific element or property that benefits the need at that particular time, and subsequently a further change in the proportion of the polymer/hot melt adhesive to the modifying component allows additional customization “on-the-fly” without the need to change the materials or process. Alternatively, a change in either the polymer/hot melt adhesive or the expanding component could result in other benefits to a particular process.

While it is envisioned that a primary role of the expanding component is density reduction, alternative designs do not necessarily depend upon the presence of expanding components to create the envisioned end property change.

These noted benefits apply to a range of dispensing options including direct discharge, spray or any other discharge of heated liquid polymer/hot melt systems.

The design of the introduction system envisions several options for the location of the introduction port for the expanding component—in the heated line, after the heated line, prior to a heat exchanger, in the applicator head or gun or post-applicator. For example, hot melt glues of high viscosity tend to stick to the exit nozzle, causing “stringing” of the glue as it exits the nozzle and is applied to a substrate. Application of a thin film of low viscosity polymer/adhesive, oil, or other non-stick substance around the core adhesive that prevents direct contact with the orifice itself would prevent stringing.

### BRIEF DESCRIPTION OF THE DRAWINGS

FIG. 1 is a schematic drawing of a first embodiment of a polymer adhesive applicator system in accordance with the invention.

FIG. 2 is a schematic drawing of a second embodiment of a hot melt adhesive applicator in accordance with the invention.

FIG. 3 is a schematic diagram of a second embodiment of an applicator system in accordance with the invention.

FIG. 4 is a schematic diagram of a control circuit in accordance with the invention.

FIG. 5 is a schematic diagram of a third embodiment of an applicator system in accordance with the invention.

FIG. 6 is a schematic diagram of a discharge nozzle in accordance with the invention.

### DETAILED DESCRIPTION OF THE PREFERRED EMBODIMENTS

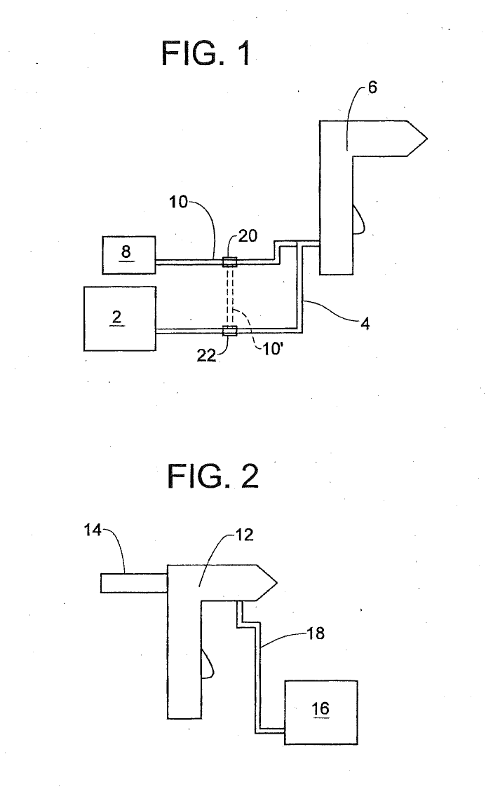

With reference to FIG. 1, a system in accordance with the invention includes a heated tank 2 having a hot melt adhesive therein maintained at a temperature whereby it can be pumped from the tank through a hose 4. The hose 4 may be heated as known in the art to maintain the hot melt adhesive at a viscosity whereby it flows through the hose. An applicator 6 is connected to the discharge end of hose 4 and may include a heat exchanger (not illustrated) to increase the temperature of the adhesive to an application temperature, if it has not been maintained at that temperature in the hose.

A second container 8 contains a flowable carrier with a modifying component, such as microspheres and is connected to the applicator 6 to mix the component with the adhesive polymer. In the embodiment shown in FIG. 1, the hose 10 connects to the inlet of the applicator, but this hose may be connected to the flow channel of the adhesive at other locations, such as the immediate inlet to a heat exchanger or to the discharge point of a heat exchanger, or other locations.

An alternate location for introduction of the modifying component is illustrated at 10′ in FIG. 1, where the modifying component is introduced to the polymer flow in hose 4 intermediate the tank and the applicator. This alternate location could be facilitated, for example, by the provision of electrically controlled valves 20 and 22. These valves can be any of several known injection systems, including for example T-connections. A control system for operating the valves is described below.

The flowable mixture in the second tank 8 is preferably a slurry comprising oil as a carrier and microspheres, the slurry being such that it flows, as by pumping, at a range of temperatures that includes room temperature. The pump is preferably able to pump a wide range of viscosities at room temperatures and perhaps increased temperatures. For example a 60/40 mixture of DRAKEOL oil and EXPANCEL was found to have a viscosity at room temperature of about 3,000 cPs. Other mixtures may have similarly high viscosities and others, such as those that include waxes can be heated to reduce the viscosity.

In addition, the pump and other equipment must be able to accommodate particulates. For example the maximum diameter of the microspheres in EXPANCEL is about 100 μm, and most are in the range of 28-38 μm.

FIG. 2 illustrates an embodiment that uses a glue stick instead of the tank-type heater of FIG. 1. The glue stick applicator 12 receives a glue stick 14 as known in the art, and a user advances it into a heat exchanger for melting. A container 16, such as a tank or other type of container, holds a flowable mixture containing microspheres and is connected to the applicator 12 by a hose 18. The mixture may be oil or other fluid capable of mixing with the melted hot melt adhesive polymer. As in the embodiment of FIG. 1, the hose 18 connects to the heat exchanger at any desired location or to the outlet of the heat exchanger, to mix the microsphere mixture with the heated adhesive.

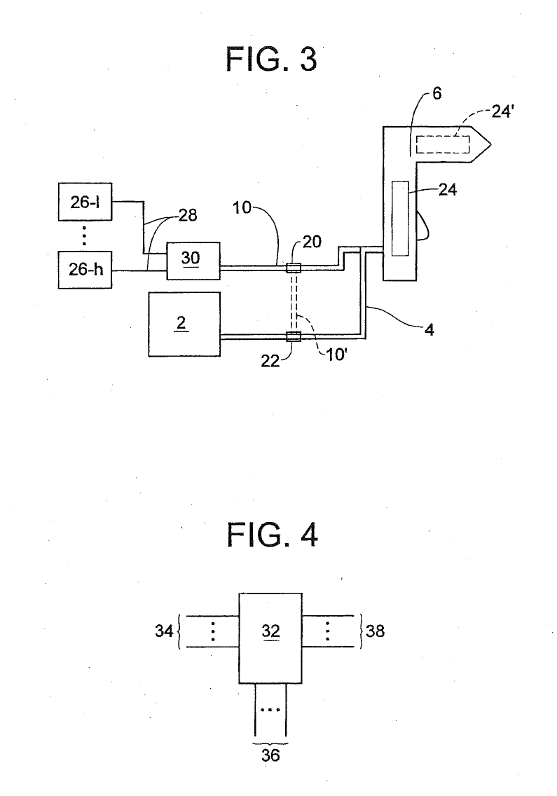

FIG. 3 illustrates a second embodiment of a polymer applicator in accordance with the invention wherein components having the same function as those shown in FIG. 1 have the same reference numerals. In the embodiment shown in FIG. 3, the heat exchanger is shown at 24, and the heat exchanger is shown at an alternate location 24′. It will be appreciated that the heat exchanger could be placed at other locations as well. The embodiment of FIG. 3 provides a plurality of sources 26 of modifying components, which are illustrated at 26-1 through 26-n. Each of the sources of modifying components 26 could be a tank having a different mixture of carrier and modifying component therein. For example, 26-1 could be a tank containing a slurry comprising carrier oil and microspheres. Another tank 26-n could contain a slurry comprising a carrier and a chemical foaming agent or a carrier with a modifying component mixed into the carrier or a carrier as a solvent and the modifying component as a solute. Additional tanks could have slurries with different proportions of carriers and modifying components, while others could contain slurries with other modifying components or solvent carriers with dissolved modifying components.

In the system of FIG. 3, outlet lines 28 connect the sources 26 of modifying components to the inlet of valve 30, the outlet of which is connected to hose 10. Valve 30 is capable of connecting any one or more of the sources 26 to hose 10, and is preferably controlled by a control system shown in FIG. 4.

In some uses of the invention, the polymer and modifying components are known and unlikely to change, and the embodiment of FIG. 1 may be adequate for that. On the other hand, a feature of the invention is that it provides flexibility whereby changes to the polymer can be made quickly and easily to adjust to different conditions. For example a user could load the tank 2 of the embodiment of FIG. 3 with a single, base polymer. Then, that polymer can be modified in a wide variety of ways quickly and easily by injecting a selected modifying component into the polymer stream. FIG. 4 illustrates an embodiment of a control system 32 in accordance with the invention that is particularly applicable to the embodiment of FIG. 3.

The control system 32 can be a programmed general purpose computer or personal computer, a microprocessor, a hard wired circuit, a group of solenoid-controlled switches and the like. Inputs to the controller are illustrated at 34 and preferably include:
a. Polymer temperature in tank 2,
b. Polymer temperature in hose 4,
c. Polymer flow rate in hose,
d. Modifying component (e.g., slurry) temperature in hose 10,
e. Modifying component flow rate,
f. Detailed program to be implemented, which would include the selection of the particular modifying component or combination of modifying components, the desired temperatures and flow rates of the polymer and modifying component(s), and the location at which the modifying component(s) are to be injected.

A first set of outputs is illustrated at 36 and preferably include:
a. Signals to control the valve 30 to provide the desired selection of mix of the modifying components, and
b. The location of injection of the modifying components, for example by control of valves 20, 22.

A second set of outputs is illustrated at 38 and preferably include:
a. Desired polymer flow rate,
b. Modifying component flow rates,
c. Tank heater control,
d. Heat exchanger power control.

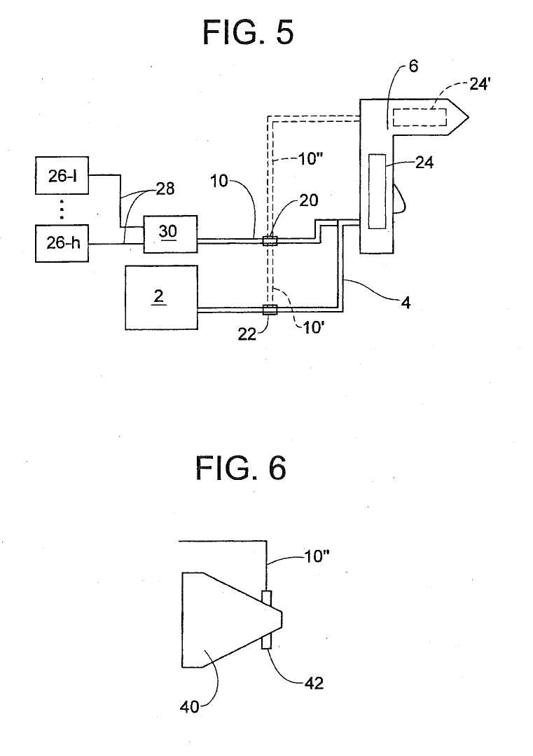

FIG. 5 illustrates an embodiment wherein a hose 10″ is connected close to the discharge nozzle to prevent sticking between the outlet nozzle and the polymer to prevent stringing. Thus, the controller 32 can direct oil or another low viscosity material, such as wax or a polymer, into the exit nozzle to reduce interactions between the polymer and the nozzle that can result in stringing. FIG. 6 illustrates a nozzle 40 with a manifold 42 connected to hose 10″, the manifold communicating with the interior of the nozzle 40, as by a plurality of openings (not shown) to provide the polymer with a thin coating to reduce or prevent stringing. Because the coating is not necessarily needed until the flow of polymer is stopped, the control 32 will sense the proper time to apply the coating and activate a valve 20 to provide the desired component.

In some instances, the modifying component will be mixed with a carrier to form a slurry, as in the case of microspheres, beads, and chemical foaming agents. In those instances, the slurry is added to the polymer. In other instances, such as with waxes, plasticizers and the like, the modifying components will be added directly to the polymer. In most instances, however, the amount either of the slurry or the modifying component to be added is small compared to the volume of the polymer. Thus, the pump providing the modifying components is preferably a precision pump with minimal response delays because the flow rates will be on the order of about 0.25 mL/min to about 7 mL/min. Of course other flow rates will obtain depending on the actual materials used. Because it may be important to maintain the pressure of the melted polymer having an expanding component to prevent premature expansion, the pumps should also be capable of providing the precise flow rates and response times with minimal pulsation in the pressures.

The modifying component flow rates can be compared with exemplary hot melt flow rates that may be in the range of from about 20 mL/min to 80 mL/min at viscosities in the range of from 6,000 cPs to 21,000 cPs and at temperatures from 250° F. to 400° F. These are examples only, the actual flow rates and viscosities depending on the materials used and the intended applications.

Specific examples of preferred compositions and their application will now be described, understanding that these are preferred and that the scope of the invention is not limited thereby

### EXAMPLE 1

A hot melt polymer packaging adhesive product is marketed by Adhesive Technologies, Inc., the assignee of this application, under the name ADTECH 660. When used with UV-printed corrugated board injecting a mixture of FORAL 105 and DRAKEOL 34 in a 50%-50% mixture into the melted polymer downstream of a tank-type dispenser of the ADTECH 660 at 15% by weight of the final carrier/modifying component/polymer provided the resulting product with significantly increased fiber-tearing adhesion.

### EXAMPLE 2

An increase in volume of about 28% was achieved by injecting a slurry of 40% EXPANCEL 031 DU and 60% DRAEKOL 34 into a stream of ADTECH 660 downstream of a tank dispenser at 1% by weight of the final carrier/modifying component/polymer.

### EXAMPLE 3

A density reduction of about 29% of ADTECH 660 was achieved by injecting a mixture of 60% water and 40% EXPANCEL 31 DU downstream of a tank type dispenser at 1% by weight of the final carrier/modifying component/polymer and at a polymer temperature of about 250° F.

### EXAMPLE 4

A general purpose adhesive product is marketed by

Adhesive Technologies, Inc. under the trademark ADTECH 220, and injection of a tackifying resin sold under the trademark DERCOLYTE LTG downstream of a tank type dispenser at 15% by weight of the final carrier/modifying component/polymer improved adhesion to low energy surfaces such as polyethylene.

### EXAMPLE 5

A mixture of EXPANCEL 031 DU and isopropyl alcohol at a proportion of 50%-50% was injected downstream into a stream of ADTECH 660 at 1% by weight of the final carrier/modifying component/polymer and at 250° F., which provided a density reduction of about 31%.

It will be appreciated that a system has been disclosed that provides great flexibility in the application of melted polymer materials, such as hot melt polymers and in their modification during application. Modifications within the scope of the appended claims will be apparent to those of skill in the art.

We claim:

1. A method of modifying the characteristics of a polymer, comprising the steps of heating the polymer to a first temperature at which the physical state of the polymer is such that it can flow and then injecting a modifying component into said heated polymer.

2. A method according to claim 1 wherein said modifying component increases the volume of the polymer.

3. A method according to claim 1 wherein said modifying component is temperature activated.

4. A method according to claim 3 wherein said modifying component is activated at about said first temperature and the heat capacity of said polymer is adequate to heat said modifying component to about said first temperature.

5. A method according to claim 3 wherein said modifying component is activated at a second temperature above said first temperature and further comprising the step of directing a mixture of said polymer and said modifying component to a heat exchanger that increases the temperature of said mixture to at least said second temperature.

6. A method according to claim 2 wherein said modifying component comprises microspheres that expand to reduce the density of the polymer.

7. A method according to claim 4 wherein said modifying component comprises microspheres that expand to reduce the density of the polymer.

8. A method according to claim 5 wherein said modifying component comprises microspheres that expand to reduce the density of the polymer.

9. A method according to claim 1 wherein said modifying component alters a chemical or physical property of said polymer.

10. A method according to claim 1 wherein said modifying component is carried in a liquid medium.

11. A method according to claim 10 wherein said liquid medium comprises water.

12. A method according to claim 10 wherein said liquid medium comprises alcohol.

13. A method according to claim 10 wherein said liquid medium comprises oil.

14. Apparatus for providing a heated polymer and combining said heated polymer with a modifying component, comprising means for heating said polymer to a first temperature at which said heated polymer is flowable, and means for injecting into said heated polymer a modifying component that will modify the physical of chemical characteristics of said heated polymer.

15. Apparatus according to claim 14 wherein said means for heating comprises a heating reservoir.

16. Apparatus according to claim 15 wherein said heating means further comprises a heated hose for receiving said heated polymer from said heated reservoir and for maintaining the heated polymer at said first temperature.

17. Apparatus according to claim 14 wherein said means for heating comprises a hand-held heating chamber.

18. In combination a carrier that is solid at room temperature combined with a modifying component.

19. The combination of claim 18 wherein said carrier is wax.

20. A method for reducing stringing in a hot melt adhesive application comprising the step of applying a thin coating of oil, wax, or polymer to said hot melt adhesive just prior to said adhesive's exiting an applicator nozzle.
